(19) United States
(12) Patent Application Publication
(10) Pub. No.: US 2006/0209824 A1
(43) Pub. Date: Sep. 21, 2006

(54) Method, apparatus, and computer program product for transmitting and receiving broadcast packets

(75) Inventors: Michael W. Ross, Great Falls, VA (US); Matthew E. Pollack, Falls Church, VA (US)

Correspondence Address: STERNE, KESSLER, GOLDSTEIN & FOX PLLC, 1100 NEW YORK AVENUE, N.W., WASHINGTON, DC, 20005, US

(73) Assignee: The MITRE Corporation, McLean, VA (US)

(21) Appl. No.: 11/067,721

(22) Filed: Mar. 1, 2005

(51) Int. Cl. H04L 12/56

(52) U.S. Cl. 370/390

(57) ABSTRACT

A method, apparatus, and computer program product for propagating broadcast packets among several subnets without configuring routers to forward broadcast packets is provided. The broadcast packets are propagated between subnets as unicast or multicast packets. Further, the broadcast packets are efficiently propagated to only the subnets that desire broadcast propagation.

### BACKGROUND OF THE INVENTION

1. Field of the Invention

The present invention relates to computer networking. More particularly, the present invention relates to transmission of broadcast packets in a computer network.

2. Background Art

Packets of a packet-based computer network can be categorized into unicast, multicast, and broadcast packets. Unicast packets are addressed and destined for a single host on the computer network. Multicast packets are addressed to a multicast group and are destined for all hosts that have subscribed to the multicast group. Broadcast packets are generally not addressed to any particular host and are destined for all hosts in the network.

Due to the indiscriminate nature of broadcast packets, routers typically do not route broadcast packets from one subnet to another. Rather, dissemination of broadcast packets is limited to the subnet from which the packet emanated. One reason for limiting the reach of broadcast packets to its subnet is for efficiency. Although, all communications between every host in the network could theoretically be achieved using broadcast packets, if most communications in the network involve only two hosts, using broadcast packets for most communications would be inefficient since the communication would be routed to more hosts than necessary. Therefore, routers typically do not forward broadcast packets to reduce the likelihood of inefficient use of the network as well as abusive uses that may lead to flooding and overloading of the network.

For example, if every router in the Internet forwarded broadcast packets, a single broadcast packet from one host would be routed and delivered to every host in the Internet. Although such a feature could be powerful, a lot of network resources could be wasted in routing broadcast packets throughout the Internet unless the information contained in each broadcast packet was useful and desired by nearly all the hosts in the Internet. Furthermore, such expansive and complete reach of broadcast packets may make the network vulnerable to abusive uses that could lead to flooding and overloading of the network. Therefore, by limiting broadcast packets to the subnet from which it originates, the network forces hosts to communicate between subnets using unicast and multicast packets. Since unicast and multicast packets are addressed to a particular host or a set of hosts, the network can efficiently utilize its resources to route packets to only the intended hosts and avoid transmitting packets extraneously to hosts that will ultimately ignore and discard the packets.

There are certain situations, however, in which propagating broadcast packets from one subnet to another can be useful. For example, many products in the simulation industry allow simulations to be executed across multiple hosts in a computer network. These products often rely on broadcast packets for communication among the hosts used in the simulation. Hence, in situations where it is desirable to have hosts in several subnets that are separated by router boundaries participate in a simulation, broadcast packets must be propagated among the subnets containing the hosts desired in the simulation. In such circumstances, routers generally cannot be configured to forward broadcast packets. Even if routers could be configured as such, routers are typically managed by network administrators and due to security and efficiency concerns, network administrators are often unlikely to configure routers to forward broadcast packets upon request.

Furthermore, where a third party controls a router, it may be impossible to convince the third party to forward broadcast packets. For example, it is unlikely that Internet Service Providers (ISP) such as AOL would configure their routers to propagate broadcast packets across its network upon request. Therefore, where it is useful to propagate broadcast packets between two subnets that are connected by a router controlled by a third party, it may be impossible to do so by configuring all the routers between the two subnets.

Hence, protocols that utilize broadcast packets such as Dynamic Host Configuration Protocol (DHCP) were generally limited to a single subnet. DHCP is a protocol that allows a new host to announce its presence and to ask the network to assign it a unique address that it can use to communicate with other hosts in the network. When a host is initially connected to the network, it generally does not know anything about other hosts in the network. Furthermore, the new host must obtain a unique address in its subnet so that the network can deliver packets to it appropriately. To obtain a unique address, the host must either discover all the addresses currently in use or communicate with a server that is knowledgeable about which addresses are available. Hence, a new host using the DHCP protocol first transmits a broadcast packet into the network to discover if a DHCP server exists in the subnet. A DHCP server is configured to assign and keep track of a group of addresses in a subnet. If a DHCP server exists, the new host and the DHCP server communicate with each other and the DHCP server assigns an available unique address to the new host.

DHCP works well in a single subnet. However, since several subnets can share a single address space, a need arose to have a single DHCP server manage and assign addresses to all new hosts in several subnets. DHCP was limited because it relies on the new host discovering the DHCP server using a broadcast packet. As such, a method of forwarding a broadcast packet from several subnets to a single DHCP server was needed. DHCP helper and IP helper were created to resolve this problem. DHCP helper and IP helper are different names used by different router vendors for software that provides the same functionality. DHCP helper runs on a router and can be configured to transmit a DHCP broadcast packet from one subnet to a DHCP server in another subnet.

Although DHCP helper transmits broadcast packets from one subnet to a DHCP server of another subnet, it is not an extensible solution to propagate broadcast packets generally among a set of subnets. First, DHCP helper recognizes only DHCP broadcast packets that are destined for a particular port. Second, DHCP helper operates on a router and therefore the use of DHCP helper is limited to only accessible routers. Third, DHCP helper transmits broadcast packets only to DHCP servers and does not propagate broadcast packets generally to all hosts in another subnet. DHCP helper converts a DHCP broadcast packet to a unicast packet and sends the unicast packet to a predefined DHCP server. Furthermore, since a DHCP server manages and assigns addresses to new hosts, DHCP helper is inapplicable among subnets that have a Network Address Translation (NAT) boundary.

Hence, DHCP helper is not applicable for allowing hosts in different subnets to communicate with each other via broadcast packets. Furthermore, as described above, routers generally cannot be configured to forward broadcast packets and even if it was possible, it is generally not a viable alternative. Even if this were possible, it could lead to inefficient use of the network. Rather than having each router forward broadcast packets to all hosts all along the network path between two subnets that require broadcast packet propagation, the network could be used more efficiently if there was a mechanism to forward broadcast packets to only the hosts of the subnets that require broadcast packet propagation.

Providing a mechanism to propagate broadcast packets among subnets efficiently without modifying routers would enable systems that rely on broadcast packets to operate in multiple subnets. Presently, many products in the simulation industry rely on broadcast packets to communicate. Hence, a general mechanism to propagate broadcast packets would enable these products to operate in network environments that contain subnets separated by router boundaries.

What is needed is a general method of propagating broadcast packets among subnets without modifying routers such that broadcast packets are efficiently broadcast only in subnets that desire broadcast packet propagation.

### BRIEF SUMMARY OF THE INVENTION

The present invention is a method, apparatus, and computer program product for propagating broadcast packets among subnets.

Among a set of subnets that desire broadcast propagation, broadcast packets in one subnet are propagated to the other subnets by transmitting the data contained in the broadcast packet of one subnet to the other subnets via unicast and multicast packets. When a unicast or multicast packet containing data from a broadcast packet of another subnet arrives at a subnet, the data contained in the received packet is broadcast using a broadcast packet.

Since broadcast packets are generally not permitted to cross router boundaries between subnets, unicast and multicast packets are used to transmit the data in the broadcast packet to different subnets. Furthermore, since unicast and multicast packets are used, routers between the subnets that require broadcast propagation do not need to be further configured or modified.

A computer device, representing an embodiment of the present invention, for example, can be placed in each subnet to execute the reception and transmission of broadcast packets. These devices are configured to be aware of each other so that they can properly transmit unicast and multicast packets among them to propagate broadcast packets only to those subnets that desire broadcast packet propagation.

The present invention also allows for selectively propagating broadcast packets based on a selection criteria. The selection criteria can be based, for example, on information related to a packet such as source address, destination address, source port, destination port, and data. Propagation of broadcast packets can be limited to those broadcast packets fulfilling the selection criteria.

The present invention operates properly among subnets, which contain Network Address Translation (NAT) boundaries and have overlapping address spaces, as long as unicast or multicast packets can be transmitted and received properly among at least one host of each subnet.

The present invention is suitable for simulation programs that rely on using broadcast packets to communicate. By utilizing an embodiment of the present invention, these simulation products can operate in a set of subnets that are separated by router boundaries.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an example of a computer network.

FIG. 2 illustrates an example of transmitting and receiving broadcast packets according to an embodiment of the present invention.

FIG. 3A and FIG. 3B illustrate a method of transmitting and receiving broadcast packets according to an embodiment of the present invention.

FIG. 4 illustrates an example of a network for transmitting and receiving broadcast packets according to an embodiment of the present invention.

FIG. 5 illustrates an example computer system in which the present invention may be implemented as programmable code.

The present invention will be described with reference to the accompanying drawings. The drawing in which an element first appears is typically indicated by the leftmost digit(s) in the corresponding reference number.

### DETAILED DESCRIPTION OF THE INVENTION

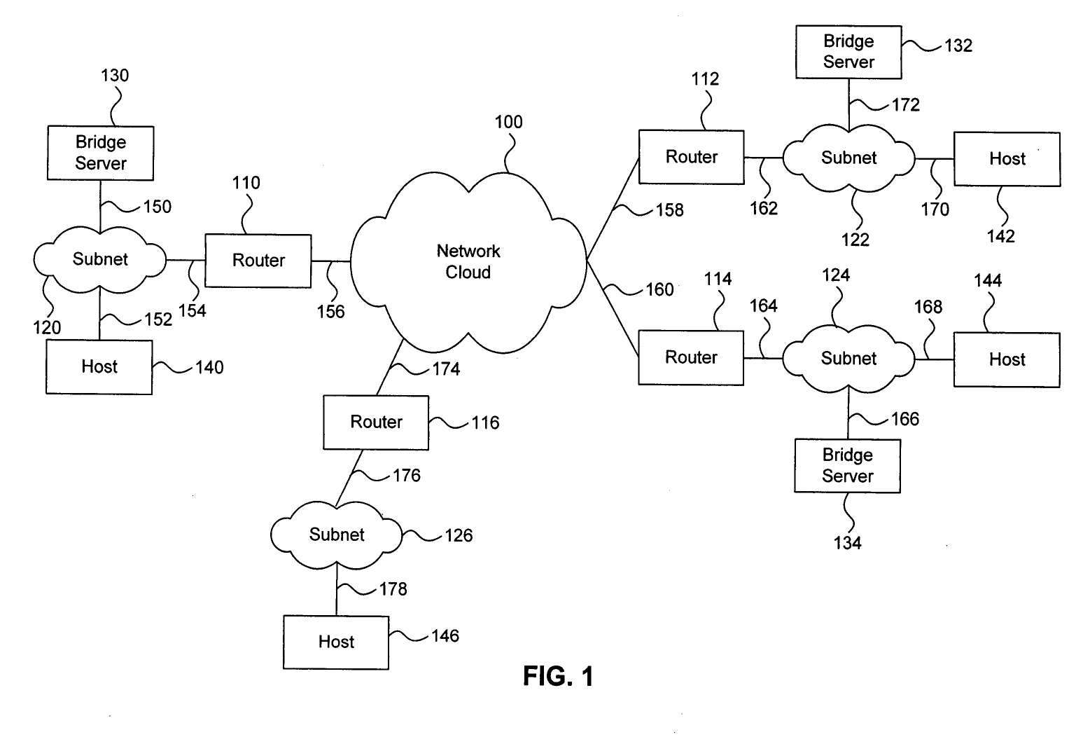

FIG. 1 illustrates an example of a computer network in which the present invention can be implemented. The computer network includes a network cloud 100, routers 110, 112, 114, and 116, subnets 120, 122, 124, and 126, Bridge Servers 130, 132, and 134, and hosts 140, 142, 144, and 146. The computer network in FIG. 1 represents a packet-based network utilizing, for example, TCP/IP packets according to the open systems interconnection (OSI) seven-layer protocol suite of the International Standards Organization (ISO).

Network connections 150-178 connect various network elements and represent OSI layers 1, 2, and 3. Network cloud 100 represents an arbitrary number of network elements and network connections. Network cloud 100 may represent, for example, the Internet. Subnets 120, 122, and 124 represent a portion of the network that is connected to the rest of the network by one or more routers. Bridge Servers 130, 132, and 134 are computer devices and represent an apparatus on which an embodiment of the present invention is implemented.

Hosts 140, 142, 144, and 146 communicate with each other by transmitting internet protocol (IP) packets through the network. For example, when host 140 wants to communicate with host 142, host 140 transmits a packet that is routed through the network to host 142. The packet that is transmitted by host 140 travels through subnet 120, router 110, network cloud 100, router 112, and subnet 122 before reaching host 142.

Unicast and multicast packets are forwarded through routers 110, 112, 114, and 116. Hence, hosts 140, 142, 144, and 146 can communicate with each other by transmitting and receiving unicast and multicast packets.

Broadcast packets, however, are not forwarded by routers 110, 112, 114, and 116. Hence, broadcast packets are limited to the subnet from which they emanate. For example, host 140 can transmit a broadcast packet to all hosts in its subnet 120. However, host 140 cannot transmit a broadcast packet to host 142.

To allow hosts 140, 142, and 144 to communicate with each other by using broadcast packets without configuring all routers between them to forward broadcast packets, Bridge Servers 130, 132 and 134, which are exemplary embodiments of an apparatus of the present invention, can be utilized.

Each Bridge Server 130, 132, and 134 can be configured, for example, to propagate broadcast packets received in its subnet to the subnets of the other Bridge Servers. For example, if host 140 transmits a broadcast packet into subnet 120, Bridge Server 130 is configured to receive the broadcast packet and transmit the data in the broadcast packet to Bridge Servers 132 and 134 via a unicast or multicast packet. Bridge Servers 132 and 134 are configured to receive the unicast or multicast packet and transmit the data from the received packet to their respective subnets 122 and 124 via a broadcast packet. Hence, hosts 142 and 144 are able to receive the data broadcast by host 140 in the form of a broadcast packet.

Furthermore, since routers 110, 112, 114, and 116 are not configured to forward broadcast packets, the broadcast packet transmitted by host 140 is not forwarded by the routers to network cloud 100 and subnets 120, 122, 124, and 126. Rather, the broadcast packet transmitted by host 140 is propagated only to specific subnets 120, 122, and 124 through Bridge Servers 130, 132, and 134, which communicate via unicast or multicast packets. By deploying embodiments of the present invention, such as Bridge Servers, in the specific subnets that desire broadcast propagation and configuring them to propagate broadcast packets to each other via unicast or multicast packets, broadcast packets can be efficiently propagated to only the specific subnets that desire broadcast propagation.

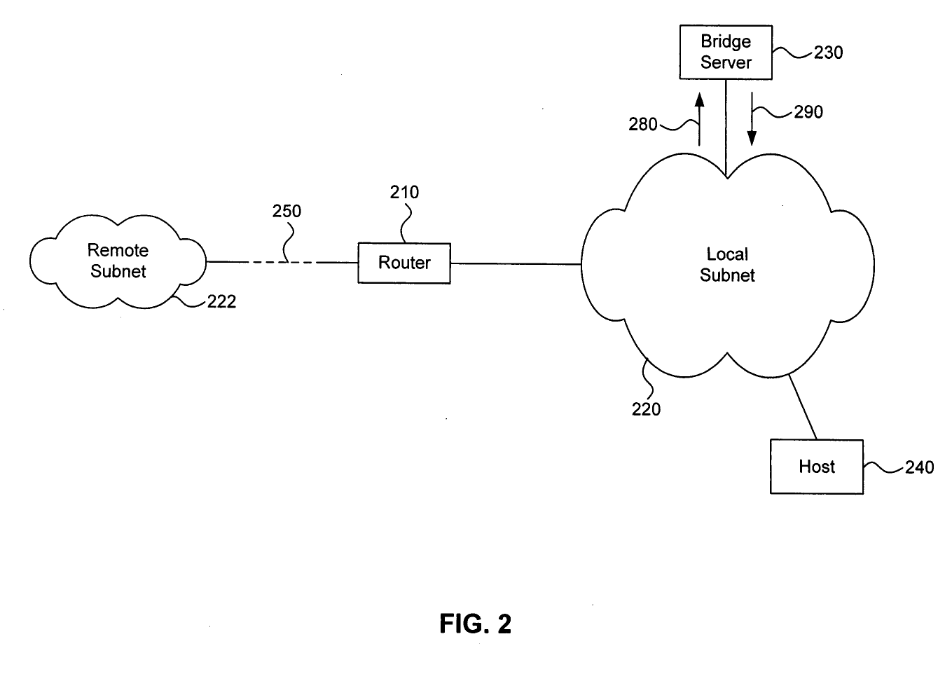

FIG. 2 illustrates an example of transmitting and receiving broadcast packets from the perspective of a single Bridge Server in accordance with an embodiment of the present invention. FIG. 2 depicts a Bridge Server 230, host 240 and router 210 that are all connected to local subnet 220. Host 240 can communicate with hosts (not shown) on a remote subnet 222 through router 210 using unicast and multicast packets. Network path 250 indicates that there is some network path to remote subnet 222. The network path 250 may include an arbitrary number of network elements such as network connections, routers, switches, satellite links, as well as any other network elements that is capable of transmiting a unicast or multicast packet, as would be appreciated by those of ordinary skill in the art.

Bridge Server 230 receives packets 280 and transmits packets 290, according to an embodiment of the present invention. Packets 280 represent broadcast packets that are present in local subnet 220 and unicast or multicast packets transmitted by another Bridger Server (not shown) from a remote subnet 222 through router 210. Packets 290 represent broadcast packets transmitted by Bridge Server 230 into the local subnet and unicast or multicast packets transmitted by Bridge Server 230 to a Bridge Server (not shown) in a remote subnet 222 through router 210. As would be appreciated by those of ordinary skill in the art, Bridge Server 230 is not limited from receiving and transmitting other packets.

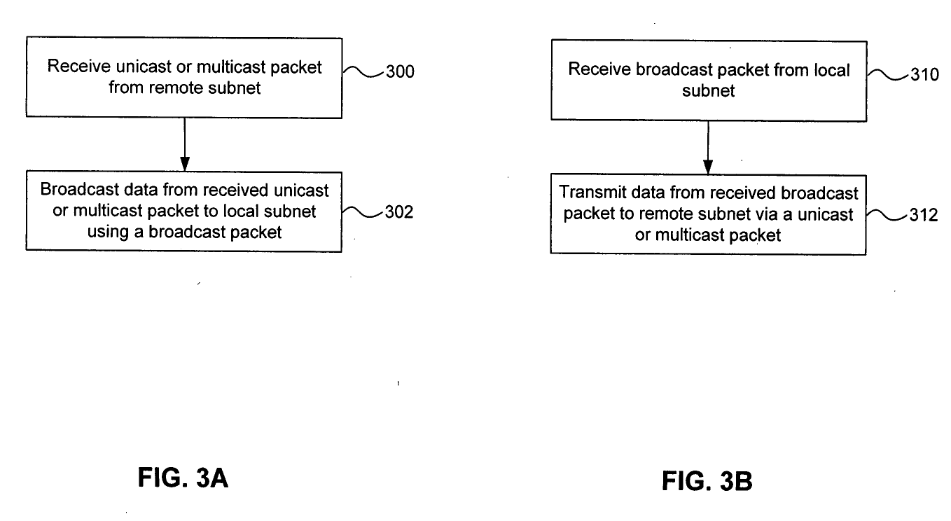

FIG. 3A illustrates a method of propagating a broadcast packet from a remote subnet to a local subnet, according to an embodiment of the present invention. In step 300, a unicast or multicast packet containing data from a broadcast packet of a remote subnet is received at the local subnet. In step 302, the data in the received unicast or multicast packet is broadcast in the local subnet using a broadcast packet.

FIG. 3B illustrates a method of propagating a broadcast packet from a local subnet to a remote subnet, according to an embodiment of the present invention. In step 310, a broadcast packet is received at the local subnet. In step 312, the data in the received broadcast packet is transmitted to one or more remote subnets via unicast or multicast packets.

Since a broadcast packet is destined for all hosts in a subnet, it is possible for an embodiment of the present invention to receive a broadcast packet that it has itself broadcast. In such circumstances, special care is taken to distinguish broadcast packets that are produced by the present invention and broadcast packets that it receives from other sources. Broadcast packets that are produced by the present invention are the end results of broadcast propagation and therefore should not be considered for further propagation. Otherwise, a ping-pong effect can occur. For example, suppose a first subnet and a second subnet are configured to propagate all broadcast packets between them. When a host in the first subnet emits a broadcast packet, the broadcast packet is propagated to the second subnet. If broadcast packets that are emitted in the second subnet through propagation are not distinguished from other broadcast packets in the second subnet, then the propagated broadcast packet in the second subnet is itself a candidate for propagation and is re-propagated back to the first subnet. This effect can continue back and forth between the two subnets and cause a ping-pong effect.

To avoid re-propagation, broadcast packets that have been broadcast into the local subnet in accordance with the method illustrated in FIG. 3A are excluded from the method illustrated in FIG. 3B. For example, broadcast packets that are emitted in step 302 to the local subnet can be marked with a particular source IP address or source port. Upon receiving a broadcast packet in step 310, the broadcast packet can be examined and any broadcast packet containing the particular source IP address or source port can be excluded from step 312 as being already propagated.

Furthermore, received packets in the methods illustrated in FIG. 3A and FIG. 3B can be filtered. Likewise, in step 312, one or more subnets can be filtered from receiving the data contained in the received broadcast packet of step 310. Both types of filtering can be performed based on information related to a packet such as source address, destination address, source port, destination port, and data. As would be appreciated by those of ordinary skill in the art, other types of filtering may be performed.

For example, suppose hosts of a simulation system communicate with each other through broadcast packets destined for port 3000. Furthermore, suppose there is a desire to distribute hosts of the simulation system on several subnets separated by router boundaries. In addition, suppose for efficiency or security concerns that only broadcast packets generated by the simulation system should be propagated among the subnets containing the hosts of the simulation system. In such a situation, an embodiment of the present invention can be deployed in each subnet that contains a host of the simulation system, and the embodiments can be configured with a filter to propagate among the several subnets only broadcast packets that are destined for port 3000. Hence, only broadcast packets that may be utilized by the simulation system are propagated among the several subnets.

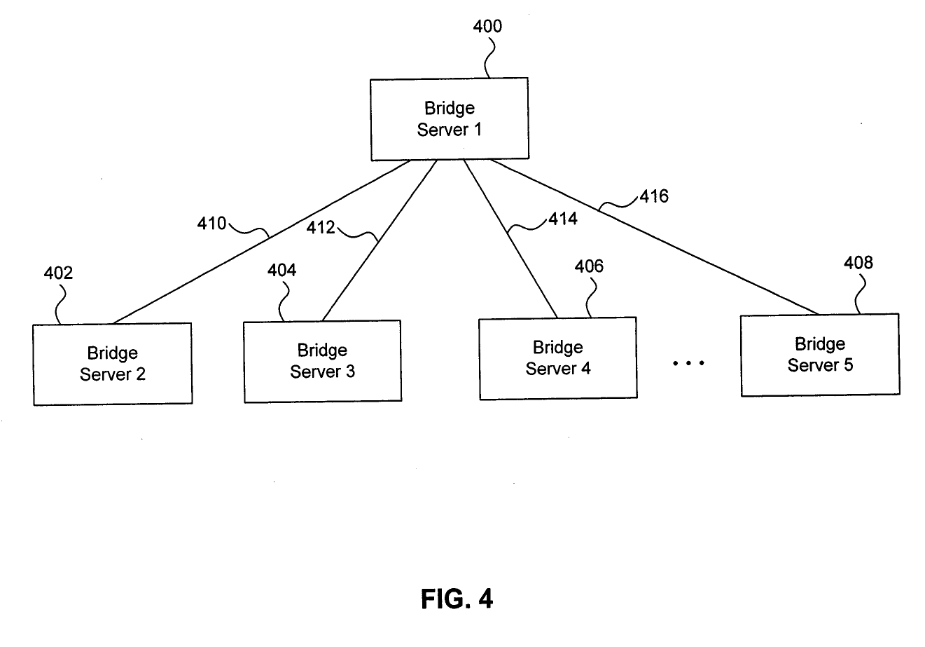

FIG. 4 illustrates a network of Bridge Servers to transmit and receive broadcast packets according to an embodiment of the present invention. Bridge Servers 402, 404, 406, and 408 are configured to forward the data contained in broadcast packets each receives from its respective subnet to Bridge Server 400 on a different subnet via a unicast or multicast packet through network paths 410, 412, 414, and 416. Bridge Server 400 is configured to forward any unicast or multicast packet it receives from one Bridge Server on the network to all other Bridge Servers on the network. Bridge Server 400 can also be configured to receive and transmit broadcast packets in its subnet and propagate them to the other Bridge Servers on the network.

FIG. 4 represents a hub and spoke model for propagating broadcast packets between several subnets. However, as would be appreciated by those skilled in the relevant art, Bridge Servers can be configured in more complex networks to propagate broadcast packets among several subnets. Furthermore, as would be appreciated by those of ordinary skill in the art, two or more Bridge Servers 400-408 are not excluded from being in the same subnet.

Multiple Bridge Servers, for example, may be deployed in a single subnet to divide the workload or responsibilities in propagating broadcast packets. In one example, one Bridge Server in a subnet may be deployed to function only as a hub to handle communications with other subnets while another Bridge Server in the same subnet is deployed to function only as a spoke to receive and emit broadcast packets in the subnet. In another example, one Bridge Server in a subnet may be configured to propagate broadcast packets that are destined for ports less than 2000 while another Bridge Server in the same subnet is configured to handle all broadcast packets destined for ports greater than or equal to 2000.

Any two Bridge Servers that can communicate with each other via a unicast or multicast packet can propagate broadcast packets between its two subnets using the present invention. Even when two subnets have non-unique address spaces and are separated by a Network Address Translation (NAT) boundary, Bridge Servers can propagate broadcast packets between the two subnets as long as the Bridge Servers can communicate with each other through unicast and multicast packets.

Since the present invention utilizes unicast and multicast packets to propagate broadcast packets among several subnets, no modifications of the routers in between the subnets are required.

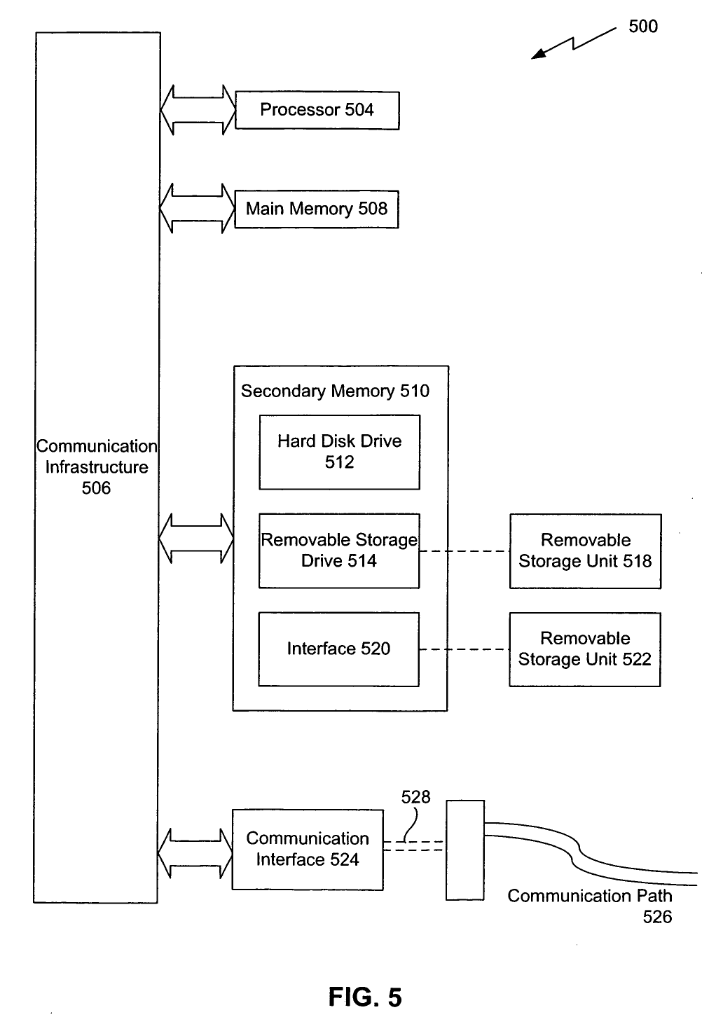

FIG. 5 illustrates an example computer system 500, in which the present invention may be implemented as programmable code. Various embodiments of the invention are described in terms of this example computer system 500. After reading this description, it will become apparent to a person skilled in the art how to implement the invention using other computer systems and/or computer architectures.

Computer system 500 includes one or more processors, such as processor 504. Processor 504 may be any type of processor, including but not limited to a special purpose or a general purpose digital signal processor. Processor 504 is connected to a communication infrastructure 506 (for example, a bus or network). Various software implementations are described in terms of this exemplary computer system. After reading this description, it will become apparent to a person skilled in the art how to implement the invention using other computer systems and/or computer architectures.

Computer system 500 also includes a main memory 508, preferably random access memory (RAM), and may also include a secondary memory 510. Secondary memory 510 may include, for example, a hard disk drive 512 and/or a removable storage drive 514, representing a floppy disk drive, a magnetic tape drive, an optical disk drive, etc. Removable storage drive 514 reads from and/or writes to a removable storage unit 518 in a well known manner. Removable storage unit 518 represents a floppy disk, magnetic tape, optical disk, etc., which is read by and written to by removable storage drive 514. As will be appreciated, removable storage unit 518 includes a computer usable storage medium having stored therein computer software and/or data.

In alternative implementations, secondary memory 510 may include other similar means for allowing computer programs or other instructions to be loaded into computer system 500. Such means may include, for example, a removable storage unit 522 and an interface 520. Examples of such means may include a program cartridge and cartridge interface (such as that found in video game devices), a removable memory chip (such as an EPROM, or PROM) and associated socket, and other removable storage units 522 and interfaces 520 which allow software and data to be transferred from removable storage unit 522 to computer system 500.

Computer system 500 may also include a communication interface 524. Communication interface 524 allows software and data to be transferred between computer system 500 and external devices. Examples of communication interface 524 may include a modem, a network interface (such as an Ethernet card), a communication port, a Personal Computer Memory Card International Association (PCMCIA) slot and card, etc. Software and data transferred via communication interface 524 are in the form of signals 528 which may be electronic, electromagnetic, optical, or other signals capable of being received by communication interface 524. These signals 528 are provided to communication interface 524 via a communication path 526. Communication path 526 carries signals 528 and may be implemented using wire or cable, fiber optics, a phone line, a cellular phone link, a radio frequency link, or any other suitable communication channel. For instance, communication path 526 may be implemented using a combination of channels.

In this document, the terms “computer program medium” and “computer usable medium” are used generally to refer to media such as removable storage drive 514, a hard disk installed in hard disk drive 512, and signals 528. These computer program products are means for providing software to computer system 500.

Computer programs (also called computer control logic) are stored in main memory 508 and/or secondary memory 510. Computer programs may also be received via communication interface 524. Such computer programs, when executed, enable computer system 500 to implement the present invention as discussed herein. Accordingly, such computer programs represent controllers of computer system 500. Where the invention is implemented using software, the software may be stored in a computer program product and loaded into computer system 500 using removable storage drive 514, hard disk drive 512, or communication interface 524, to provide some examples.

In alternative embodiments, the invention can be implemented as control logic in hardware, firmware, or software or any combination thereof.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A computer-based method of receiving and transmitting broadcast packets, comprising:
selecting a first broadcast packet in a first subnet;
specifying a second subnet, wherein the first subnet is different from the second subnet;
transmitting the data contained in the first broadcast packet to the second subnet via one of a unicast packet and a multicast packet, wherein the transmitted packet is forwarded through a router;
receiving a packet in the first subnet from the second subnet, wherein the received packet is one of a unicast packet and a multicast packet; and
broadcasting the data contained in the received packet to the first subnet using a broadcast packet.

2. The method of claim 1, wherein the specifying step further comprises specifying a computer device in the second subnet,
wherein the transmitting step comprises transmitting the data contained in the first broadcast packet to the computer device of the second subnet via one of a unicast packet and a multicast packet, wherein the computer device broadcasts the transmitted data using a broadcast packet in the second subnet, and
wherein the receiving step comprises receiving a packet that was transmitted by the computer device of the second subnet, the received packet containing data from a broadcast packet of the second subnet.

3. The method of claim 1, wherein the specifying step further comprises specifying a third subnet, wherein the third subnet is different from the first subnet and the second subnet, and
wherein the transmitting step further comprises transmitting the data contained in the first broadcast packet to the third subnet via one of a unicast packet and a multicast packet, wherein the transmitted packet is forwarded through a router.

4. The method of claim 1, wherein the selecting step comprises:
specifying a broadcast packet selection criteria; and
selecting the first broadcast packet in the first subnet wherein the selected first broadcast packet matches the broadcast packet selection criteria.

5. The method of claim 4, wherein the broadcast packet selection criteria comprises at least one of destination IP address, source IP address, destination port, source port, and data.

6. The method of claim 1, wherein the address space of the first subnet is not unique with respect to the address space of the second subnet.

7. The method of claim 1, wherein the first broadcast packet is a communication for a simulation device.

8. An apparatus for receiving and transmitting broadcast packets, comprising:
selecting means for selecting a first broadcast packet in a first subnet;
specifying means for specifying a second subnet, wherein the first subnet is different from the second subnet;
transmitting means for transmitting the data contained in the first broadcast packet to the second subnet via one of a unicast packet and a multicast packet, wherein the transmitting means forwards the transmitted packet through a router;
receiving means for receiving a packet in the first subnet from the second subnet, wherein the received packet is one of a unicast packet and a multicast packet; and
broadcasting means for broadcasting the data contained in the received packet to the first subnet using a broadcast packet.

9. The apparatus of claim 8, wherein the specifying means specifies a computer device in the second subnet,
wherein the transmitting means transmits the data contained in the first broadcast packet to the computer device of the second subnet via one of a unicast packet and a multicast packet, wherein the computer device broadcasts the transmitted data using a broadcast packet in the second subnet, and
wherein the receiving means receives a packet that was transmitted by the computer device of the second subnet, the received packet containing data from a broadcast packet of the second subnet.

10. The apparatus of claim 8, wherein the specifying means specifies a third subnet third subnet, wherein the third subnet is different from the first subnet and the second subnet, and
wherein the transmitting means transmits the data contained in the first broadcast packet to the third subnet via one of a unicast packet and a multicast packet, wherein the transmitting mans forwards the transmitted packet through a router.

11. The apparatus of claim 8, wherein the selecting means comprises:
second specifying means for specifying a broadcast packet selection criteria such that the selecting means selects as the first broadcast packet in the first subnet a broadcast packet that matches the broadcast packet selection criteria.

12. The apparatus of claim 11, wherein the broadcast packet selection criteria comprises at least one of destination IP address, source IP address, destination port, source port, and data.

13. The apparatus of claim 8, wherein the address space of the first subnet is not unique with respect to the address space of the second subnet.

14. The apparatus of claim 8, wherein the first broadcast packet is a communication for a simulation device.

15. A computer program product comprising a computer useable medium having computer readable program code means embedded in said medium for causing a computer in a first subnet to receive and transmit broadcast packets, comprising:
first computer readable program code means for causing the computer to select a first broadcast packet in a first subnet;
second computer readable program code means for causing the computer to specify a second subnet, wherein the first subnet is different from the second subnet;
third computer readable program code means for causing the computer to transmit the data contained in the first broadcast packet to the second subnet via one of a unicast packet and a multicast packet, wherein the transmitted packet is forwarded through a router;
fourth computer readable program code means for causing the computer to receive a packet in the first subnet from the second subnet wherein the received packet is one of a unicast packet and a multicast packet; and
fifth computer readable program code means for causing the computer to broadcast the data contained in the received packet to the first subnet using a broadcast packet.

16. The computer program product of claim 15, wherein the first computer program code means causes the computer to specify a computer device in the second subnet,
wherein the third computer program code means causes the computer to transmit the data contained in the first broadcast packet to the computer device of the second subnet via one of a unicast packet and a multicast packet, wherein the computer device broadcasts the transmitted data using a broadcast packet in the second subnet, and
wherein the fourth computer program code means causes the computer to receive a packet that was transmitted by the computer device of the second subnet, the received packet containing data from a broadcast packet of the second subnet.

17. The computer program product of claim 15, wherein the first computer program code means causes the computer to specify a third subnet, wherein the third subnet is different from the first subnet and the second subnet, and
wherein the third computer readable program code means causes the computer to transmit the data contained in the first broadcast packet to the third subnet via one of a unicast packet and a multicast packet, wherein the transmitted packet is forwarded through a router.

18. The computer program product of claim 15, wherein the first computer program code means causes the computer to specify a broadcast packet selection criteria, and causes the computer to select the first broadcast packet in the first subnet wherein the first broadcast packet matches the broadcast packet selection criteria.

19. The computer program product of claim 18, wherein the broadcast packet selection criteria comprises at least one of destination IP address, source IP address, destination port, source port, and data.

20. The computer program product of claim 15, wherein the address space of the first subnet is not unique with respect to the address space of the second subnet.

21. The computer program product of claim 15, wherein the first broadcast packet is a communication for a simulation device.
